(19) United States
(12) Patent Application Publication
(10) Pub. No.: US 2018/0130254 A1
(43) Pub. Date: May 10, 2018

(54) INDOOR GEOSPATIAL SITE BUILDER ENGINE

(71) Applicant: General Electric Company, Schenectady, NY (US)

(72) Inventors: Philip Crawley, Glen Allen, VA (US); Shawn Reed, Glen Allen, VA (US); Doug Brabrand, Glen Allen, VA (US); Ricardo Alexander, Glen Allen, VA (US)

(21) Appl. No.: 15/347,206

(22) Filed: Nov. 9, 2016

(51) Int. Cl. G06T 17/05; G06T 17/20

(52) U.S. Cl. CPC G06T 17/05; G06T 2210/04; G06T 17/20

(57) ABSTRACT

Systems and techniques for an indoor geospatial site builder engine are presented. A system can convert facility artifacts into geospatially-defined indoor space geometry and provides a rich user experience to visualize the facility's indoor space identifying important landmarks as well as providing controls to navigate the indoor space. The system can also provide the ability to record and change the location of fixed assets at run time as well as verify the location of fixed assets in indoor space in real-time. Similarly, geometries can be updated in real-time. The system further provides the geospatial capability to determine precise distances between assets, devices and other points of interest that are defined independently in separate geo-referenced maps that represent space in various facilities across the globe. The location validation component provides for validation of system device locations over time with the actual device location.

### BACKGROUND

This invention relates to systems, methods, and computer program products relating to provisioning and managing custom indoor space source artifacts. More particularly, the invention relates to creating location hierarchies, associating logical attributes, managing facility layout changes over time and visualizing geometries of indoor space.

### SUMMARY

The following presents a simplified summary of the specification in order to provide a basic understanding of some aspects of the specification. This summary is not an extensive overview of the specification. It is intended to neither identify key or critical elements of the specification, nor delineate any scope of the particular implementations of the specification or any scope of the claims. Its sole purpose is to present some concepts of the specification in a simplified form as a prelude to the more detailed description that is presented later.

In accordance with non-limiting implementation, a system includes a site builder component, an indoor space visualization component, an asset management visualization component, a geometry/GIS services component and a location validation component. The site builder component converting facility artifacts into indoor space geometry. The indoor space visualization component provides a rich user experience to visualize the facility's indoor space identifying important landmarks as well as providing controls to navigate the indoor space. The asset management and visualization component provides the ability to record and change and verify the location of fixed assets (all manner of devices, readers, dispensers, etc.) in the indoor space. The Geometry/GIS service component provides intrinsic GIS functions to answer location hierarchy and location-derived questions. The location validation component provides for validation of system device locations over time with the actual device location.

In accordance with another non-limiting implementation, a computer readable storage device comprising instructions that, in response to execution, cause a system comprising a processor to perform operations, comprising: converting facility artifacts into indoor space geometry; providing a rich user experience to visualize the facility's indoor space identifying important landmarks as well as providing controls to navigate the indoor space; providing the ability to record and change and verify the location of fixed assets in the indoor space; providing intrinsic GIS functions to answer location hierarchy and location-derived questions and providing location validation for system device locations over time with the actual device location.

The following description and the annexed drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

Numerous aspects, implementations, objects and advantages of the present invention will be apparent upon consideration of the following detailed description, taken in conjunction with the accompanying drawings, in which like reference characters refer to like parts throughout, and in which:

FIGS. 1-2 illustrate a high-level block diagram of an example indoor geospatial site builder system, in accordance with various aspects and implementations described herein.

FIGS. 3-4 shows a flow diagram illustrating an example method of operating the system of FIG. 2 for mapping, analyzing and displaying assets, according to the present disclosure.

FIG. 5 shows asset location—near field location w/far field confidence updates

FIG. 6 is a schematic block diagram illustrating a suitable operating environment.

FIG. 7 is a schematic block diagram of a sample-computing environment.

### DETAILED DESCRIPTION

Various aspects of this disclosure are now described with reference to the drawings, wherein like reference numerals are used to refer to like elements throughout. In the following description, for purposes of explanation, numerous specific details are set forth in order to provide a thorough understanding of one or more aspects. It should be understood, however, that certain aspects of this disclosure may be practiced without these specific details, or with other methods, components, materials, etc. In other instances, well-known structures and devices are shown in block diagram form to facilitate describing one or more aspects.

Systems and techniques for provisioning indoor space source artifacts for their geometry and management of the geometry to account for layout changes over time are presented. For example, as compared to conventional indoor source location methods for locating assets within a facility, the subject innovations provide for accurate placement of artifacts using a visualization of the geometry in a rich presentation with powerful controls and the definition of a varied physical and logical attributes associated with an indoor space.

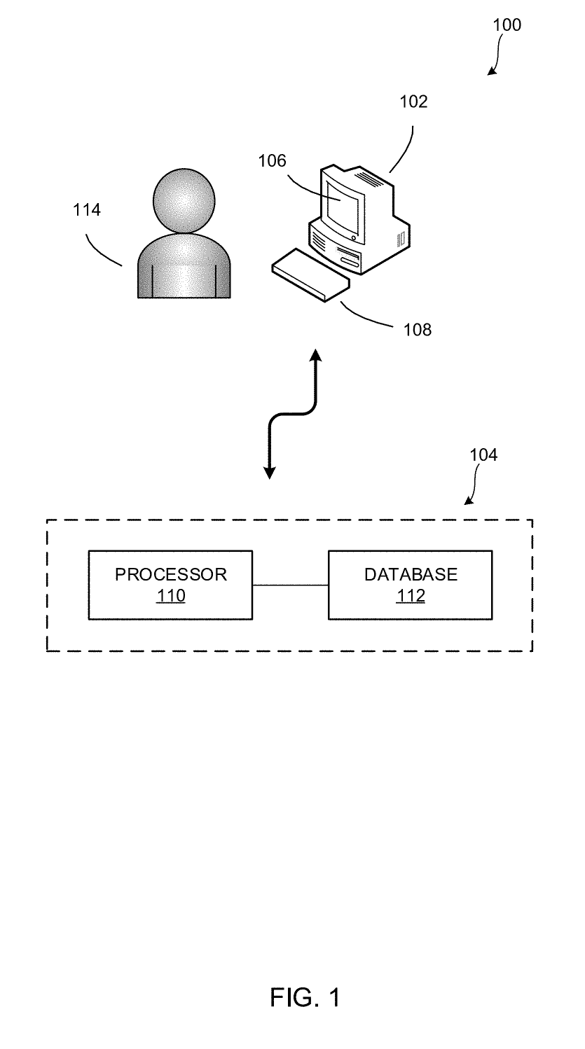

Referring initially to FIG. 1, there is illustrated an example system 100 that provides provisioning indoor space source artifacts for their geometry and management of the geometry to account for layout changes over time, according to an aspect of the subject disclosure. The system 100 can be employed by various systems, such as, but not limited to modeling systems, simulation systems, enterprise solution systems, artificial intelligence systems, machine learning systems, neural network systems, and the like. In one example, the system 100 can be associated with a viewer system to facilitate visualization and/or interpretation of location data. Moreover, the system 100 and/or the components of the system 100 can be employed to use hardware and/or software to solve problems that are highly technical in nature (e.g., related to processing location data, related to location modeling, related to artificial intelligence, etc.), that are not abstract and that cannot be performed as a set of mental acts by a human.

System 100 includes a computer 102 and an indoor geospatial site builder engine 104 communicatively coupled to computer 102. In this example, computer 102 includes a user interface 106 and a data input (e.g., a keyboard, mouse, microphone, etc.) 108 and indoor geospatial site builder engine 104 includes a processor 110 and a database 112.

In certain aspects, user interface 106 displays data such as data and images received from indoor geospatial site builder engine 104. In certain aspects, user interface 106 receives commands and/or input from a user 114 via data input 108. In certain aspects where system 100 is used to provision indoor space artifacts, user interface 106 displays a geospatial, and asset-related data.

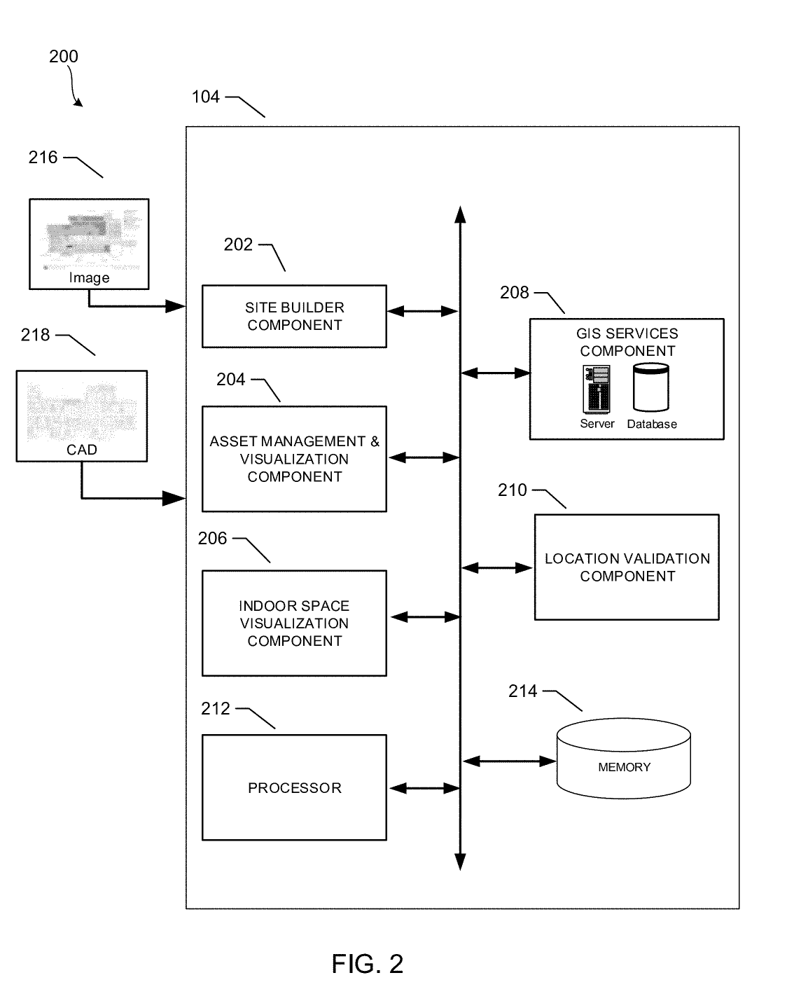

Referring to FIG. 2, indoor geospatial site builder engine 104 can include a site builder component 202, an asset management and visualization component 204, an indoor space visualization component 206, and a GIS services component 208 and a location validation component 210. Aspects of the systems, apparatuses or processes explained in this disclosure can constitute machine-executable component(s) embodied within machine(s), e.g., embodied in one or more computer readable mediums (or media) associated with one or more machines. Such component(s), when executed by the one or more machines, e.g., computer(s), computing device(s), virtual machine(s), etc. can cause the machine(s) to perform the operations described. The system 100 (e.g., the site builder component 202) can include memory 214 for storing computer executable components and instructions. The system 100 (e.g., the site builder component 202) can further include a processor 212 to facilitate operation of the instructions (e.g., computer executable components and instructions) by the system 100 (e.g., the site builder component 202).

The site builder component 202 can perform converting facility artifacts (e.g., from image data 216 or CAD data 218) into indoor space geometry. In addition, site builder component 102 can define product agnostic attributes for the geometry (i.e., identifying rooms, bathrooms, etc.) as well as supports management of the geometry as the facility's structure and layout changes. Site builder component 202 functions to geospatially locate sensors that are used to position mobile assets as they move throughout the facility. Site builder component 202 provides the ability for having 3D geospatial capabilities, for example, enabling the ability to define a latitude, longitude and floor-level index for any asset within the defined geospatial space. This helps in correctly locating the nearest asset regardless of floor. Thus, enabling a true 3D capability as opposed to current techniques which are limited to locating assets on the same floor (in two-dimensions). In addition, the geospatial capability of site builder component 202 provides the ability to determine precise distances between assets, devices and other points of interest that are defined independently in separate geo-referenced maps that represent space in various facilities across the globe.

The asset management and visualization component 204 can provide the capabilities to record and change the location of fixed assets (all manner of devices, readers, dispensers, etc.). In addition, asset management and visualization component 204 provides for display of real-time location of tagged, movable assets as well as a visual solution to clustering of assets in given places (e.g., clean/soiled utility rooms). In certain aspects, asset management and visualization component 204 provides the ability track assets across multiple facilities.

The indoor space visualization component 206 can provide the ability to visualize a facility's indoor space identifying important landmarks (e.g., stairs, bathrooms, rooms, zones, etc.).

The geometry/GIS services component 208 can provide middle and data tier services necessary to support site builder component 202, asset management and visualization component 204 and indoor space visualization component 206 such as utilizing intrinsic GIS functions to determine location hierarchy (e.g., is room x in zone y?) and location derived issues (e.g., what assets are closest to location x).

The location validation component 210 can provide the ability for installers and customers to verify system detected locations/movements with actual location/movements which has the advantage of shortening installation and tuning time for installers, improved system performance, increased confidence for the customer and reduced support costs for the customer and supplier.

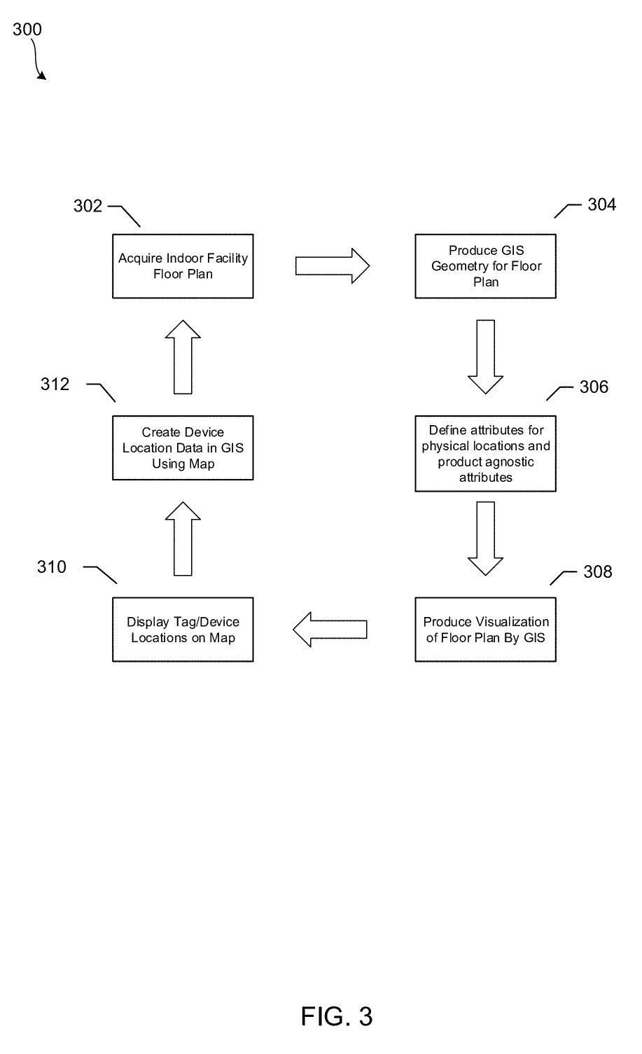

Referring to FIG. 3, there is illustrated a non-limiting implementation of a system 100 in accordance with various aspects and implementations of this disclosure. Site builder component 202 can acquire an indoor facility plans 302 in either CAD or other image format. Site builder component 202 can transform these facility plans into GIS geometry floor plan 304; creating maps with one or more layers which represent different entities (e.g., floors, areas, rooms, etc.). Site builder component 202 can store the GIS coordinates into GIS services component 208. Indoor space visualization component 206 can render a map containing polygons and GIS coordinates and allows for the definition of metadata to describe the polygons (e.g., metadata information can include name, location name, device type, location type, region type, region name, etc.).

Thus, indoor space component 206 can provide the ability to create regions, associate polygons to certain regions and also assign logistical information to each of the polygons. In certain aspects, indoor space component 206 can define attributes for physical locations and product agnostic attributes 306.

Asset management and visualization component 204 can produce visualization of floor plan by GIS 308. In certain aspects, it can provide the ability to display ‘Display tag/device locations on the map 310. In certain aspects, asset management and visualization component 204 can display ‘real world’, GIS location and asset information which can include asset health, that is detected by the RTLS system. Asset management and visualization component 204 can create device location data in GIS 312 and display the location and GIS coordinates of assets as they appear in the facility on the map. In certain aspects, asset management and visualization component 204 can display a collection of assets as they appear in the facility on the map; showing the number of assets in any given portion of the map.

Asset management and visualization component 204 can determine the region or location where the asset's location including where the device is that is responsible for locating that asset. In certain aspects, asset management and visualization component 204 can provide virtual layout views to help set up devices in specific facility locations.

In certain aspects, asset management and visualization component 204 can determine facility device inventory. For example, how many devices have been assigned, how many are being used properly, etc. In certain aspects, asset management and visualization component 204 can auto-assign devices by providing automatic assignment and device placement across a facility.

The asset management and visualization component 204 can determine and/or provide properties associated with the device to facilitate analysis and/or determination of device health and/or status. For example, asset management and visualization component 204 can determine and/or provide mechanical properties and/or physical properties of the device. Mechanical properties and/or physical properties associated with the device can include, for example, the battery power of the device and/or another property of the device. In an aspect, the asset management and visualization component 204 can determine properties associated with the device based on a model associated with the device. In another aspect, the asset management and visualization component 204 can store and/or access a list of devices and associated properties to determine properties associated with the device. For example, properties of the device can be previously determined using one or more measuring tools and/or one or more quantitative metric techniques.

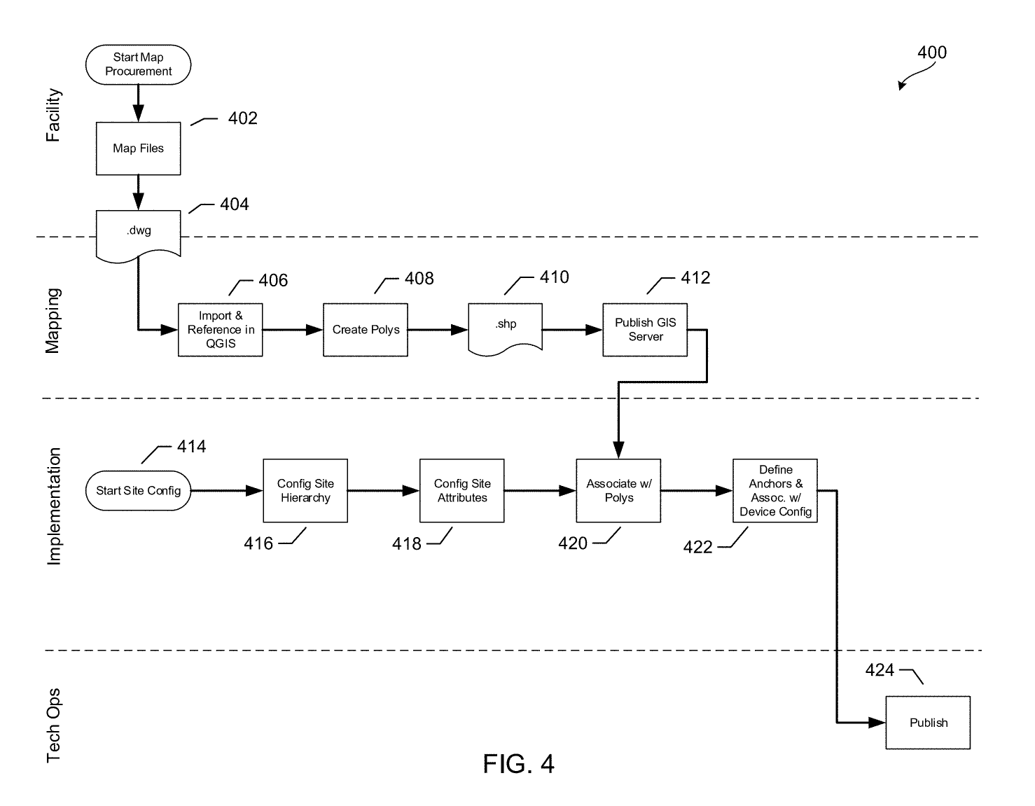

Referring now to FIG. 4, there is illustrated a non-limiting implementation of a system 100 in accordance with various aspects and implementations of this disclosure. Map procurement begins with the map files 402 provided by the facility. Map files 402 are converted into CAD drawing files (.dwg 404). CAD drawing files (.dwg) 404 are then imported into QGIS and referenced and geo-referenced 406. GIS layers 408 are created to represent the floor, area and room layers. Polygons are created to represent each are of interest. Layers are saved into .shp files 410 and then into GIS database 412. In certain aspects, independently from the map layer creation, a user may begin creating meta data for each polygon 414. Site configuration hierarchy 416 is created which can produce floor, area and room meta data, etc., for example. Site attributes 418 can also be assigned to help define the polygons. Meta data can be associated with the polygons on the map 420. In addition, anchors can be defined and associated with device configuration 422. This associates the virtual devices which are tied to a polygon with the actual installed devices (fixed receivers and fixed beacons). Once this has been accomplished, in certain aspects, an event is published 424 from Site Builder to all interested components (those that leverage map information) which indicates that site changes have been made.

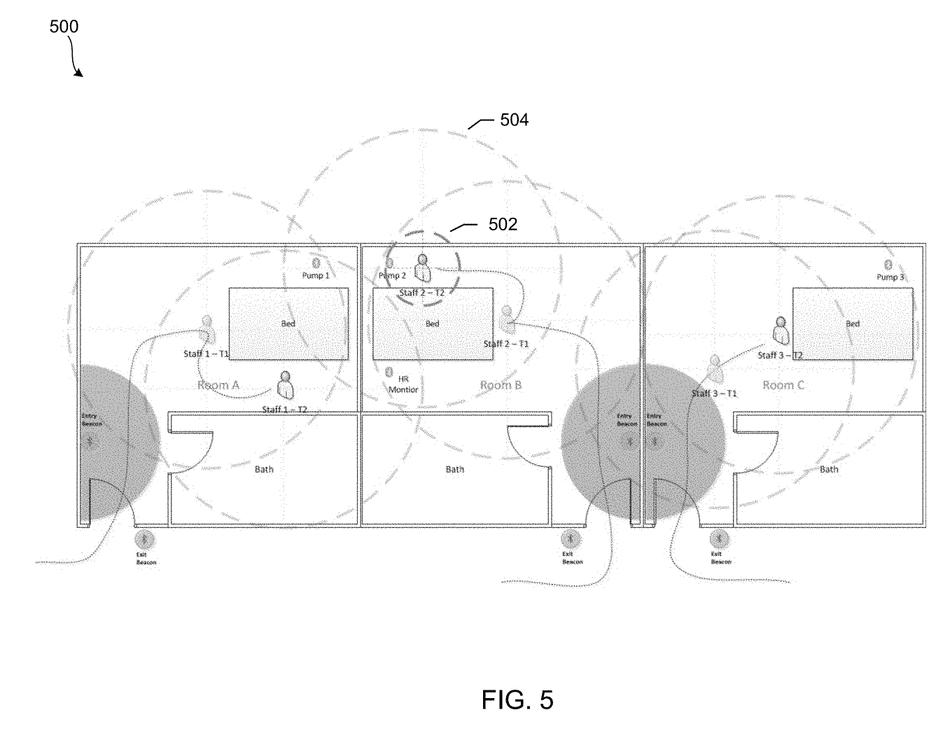

Referring now to FIG. 5, there is illustrated a non-limiting implementation of a system 100 in accordance with various aspects and implementations of this disclosure. Due to the large number of devices and configuration options required/available in a real-time location platform, it is important to have tools available to validate the location information reported by the system to ensure that it accurately reflects the locations of the devices. In certain aspects, location validation component 210 can provide a mechanism for collecting actual location as a device moves through an environment, overlay the actual movements with the system detected movements and present summary statistics.

In certain aspects, this system location validation can occur in real-time. In addition, location validation component 210 can be used during initial system setup of a real-time location system to ensure accurate functioning of the system and for on-going validation and tuning of the entire system. In certain aspects, asset beacons detected in near proximity to staff badge are assigned location of staff 502, for example. In certain aspects, asset beacons detected in a wide radius of staff badge are reported for use in confidence estimate assign location.

In certain aspects, location validation component 210 can provide a browser-based user interface by which a user can capture travel logs of device location movements throughout an environment and chart those movements against system detected movement data of a real-time location platform. In certain aspects, the overlap of actual location and detected location over time can represent the accuracy of the system. In certain aspects, travel logs can present a clickable map location by which a user can collect location movements within the environment and the precise timing of those movements. In certain aspects, an actuality chart can present a chart in which the location movements captured by the travel log are overlaid with the system-detected movements, and summary statistics representing the accuracy of the system can be displayed, for example. Discrepancies between actual location and detected location can be presented in the actuality chart and represent system tuning/improvement opportunities or call out installation problems that should be addressed by the customer or platform provider. In certain aspects, the system can generate an alert of the discrepancies by sending the information to a designated person by email, text message, or any similar notification methods.

The aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

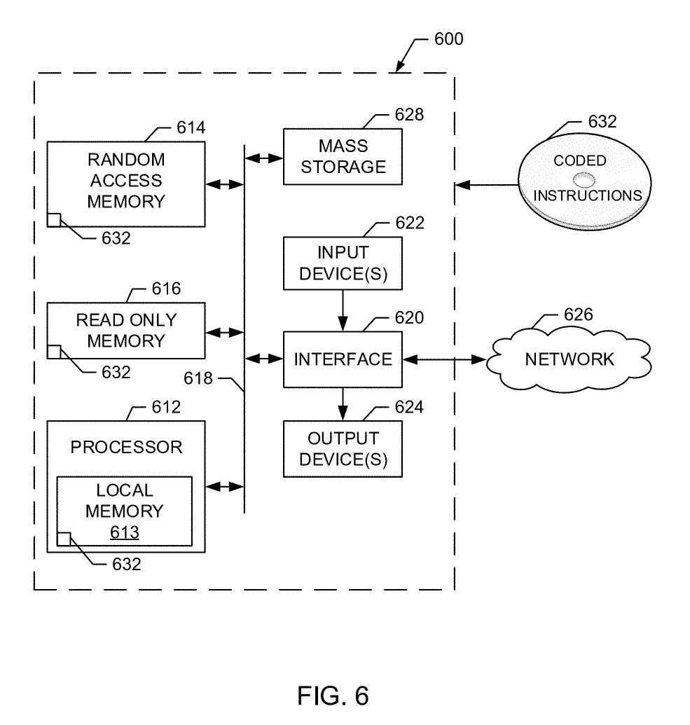

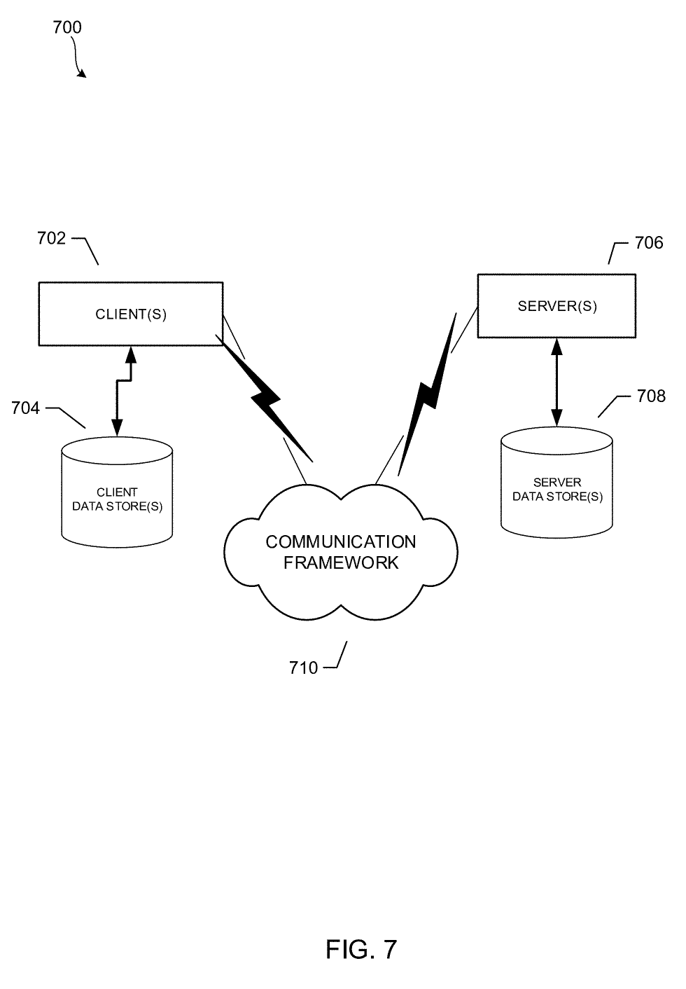

In order to provide a context for the various aspects of the disclosed subject matter, FIGS. 6 and 7 as well as the following discussion are intended to provide a brief, general description of a suitable environment in which the various aspects of the disclosed subject matter may be implemented.

FIG. 6 is a block diagram of an example processor platform 600 capable of executing the instructions of FIG. 2 to implement the example indoor geospatial site builder engine. The processor platform 600 can be, for example, a server, a personal computer, a mobile device (e.g., a cell phone, a smart phone, a tablet such as an IPAD™), a personal digital assistant (PDA), an Internet appliance, or any other type of computing device.

The processor platform 600 of the illustrated example includes a processor 612. Processor 612 of the illustrated example is hardware. For example, processor 612 can be implemented by one or more integrated circuits, logic circuits, microprocessors or controllers from any desired family or manufacturer.

Processor 612 of the illustrated example includes a local memory 613 (e.g., a cache). Processor 612 of the illustrated example is in communication with a main memory including a volatile memory 614 and a non-volatile memory 616 via a bus 618. Volatile memory 614 can be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 616 can be implemented by flash memory and/or any other desired type of memory device. Access to main memory 614, 616 is controlled by a memory controller.

Processor platform 600 of the illustrated example also includes an interface circuit 620. Interface circuit 620 can be implemented by any type of interface standard, such as an Ethernet interface, a universal serial bus (USB), and/or a PCI express interface.

In the illustrated example, one or more input devices 622 are connected to the interface circuit 620. Input device(s) 622 permit(s) a user to enter data and commands into processor 612. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 624 are also connected to interface circuit 620 of the illustrated example. Output devices 624 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). Interface circuit 620 of the illustrated example, thus, typically includes a graphics driver card, a graphics driver chip or a graphics driver processor.

Interface circuit 620 of the illustrated example also includes a communication device such as a transmitter, a receiver, a transceiver, a modem and/or network interface card to facilitate exchange of data with external machines (e.g., computing devices of any kind) via a network 626 (e.g., an Ethernet connection, a digital subscriber line (DSL), a telephone line, coaxial cable, a cellular telephone system, etc.).

Processor platform 600 of the illustrated example also includes one or more mass storage devices 628 for storing software and/or data. Examples of such mass storage devices 628 include floppy disk drives, hard drive disks, compact disk drives, Blu-ray disk drives, RAID systems, and digital versatile disk (DVD) drives.

Coded instructions 632 of FIG. 2 can be stored in mass storage device 628, in volatile memory 614, in the non-volatile memory 616, and/or on a removable tangible computer readable storage medium such as a CD or DVD.

FIG. 7 is a schematic block diagram of a sample-computing environment 700 with which the subject matter of this disclosure can interact. The system 700 includes one or more client(s) 702. The client(s) 702 can be hardware and/or software (e.g., threads, processes, computing devices). The system 700 also includes one or more server(s) 706. Thus, system 700 can correspond to a two-tier client server model or a multi-tier model (e.g., client, middle tier server, data server), amongst other models. The server(s) 706 can also be hardware and/or software (e.g., threads, processes, computing devices). The servers 706 can house threads to perform transformations by employing this disclosure, for example. One possible communication between a client 702 and a server 706 may be in the form of a data packet transmitted between two or more computer processes.

The system 700 includes a communication framework 710 that can be employed to facilitate communications between the client(s) 702 and the server(s) 706. The client(s) 702 are operatively connected to one or more client data store(s) 704 that can be employed to store information local to the client(s) 702. Similarly, the server(s) 706 are operatively connected to one or more server data store(s) 708 that can be employed to store information local to the servers 706.

It is to be noted that aspects or features of this disclosure can be exploited in substantially any wireless telecommunication or radio technology, e.g., Wi-Fi; Bluetooth; Worldwide Interoperability for Microwave Access (WiMAX); Enhanced General Packet Radio Service (Enhanced GPRS); Third Generation Partnership Project (3GPP) Long Term Evolution (LTE); Third Generation Partnership Project 2 (3GPP2) Ultra Mobile Broadband (UMB); 3GPP Universal Mobile Telecommunication System (UMTS); High Speed Packet Access (HSPA); High Speed Downlink Packet Access (HSDPA); High Speed Uplink Packet Access (HSUPA); GSM (Global System for Mobile Communications) EDGE (Enhanced Data Rates for GSM Evolution) Radio Access Network (GERAN); UMTS Terrestrial Radio Access Network (UTRAN); LTE Advanced (LTE-A); etc. Additionally, some or all of the aspects described herein can be exploited in legacy telecommunication technologies, e.g., GSM. In addition, mobile as well non-mobile networks (e.g., the Internet, data service network such as internet protocol television (IPTV), etc.) can exploit aspects or features described herein.

While the subject matter has been described above in the general context of computer-executable instructions of a computer program that runs on a computer and/or computers, those skilled in the art will recognize that this disclosure also can or may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., PDA, phone), microprocessor-based or programmable consumer or industrial electronics, and the like. The illustrated aspects may also be practiced in distributed computing environments where tasks are performed by remote processing devices that are linked through a communications network. However, some, if not all aspects of this disclosure can be practiced on stand-alone computers. In a distributed computing environment, program modules may be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

Various aspects or features described herein can be implemented as a method, apparatus, system, or article of manufacture using standard programming or engineering techniques. In addition, various aspects or features disclosed in this disclosure can be realized through program modules that implement at least one or more of the methods disclosed herein, the program modules being stored in a memory and executed by at least a processor. Other combinations of hardware and software or hardware and firmware can enable or implement aspects described herein, including a disclosed method(s). The term “article of manufacture” as used herein can encompass a computer program accessible from any computer-readable device, carrier, or storage media. For example, computer readable storage media can include but are not limited to magnetic storage devices (e.g., hard disk, floppy disk, magnetic strips . . . ), optical discs (e.g., compact disc (CD), digital versatile disc (DVD), blu-ray disc (BD) . . . ), smart cards, and flash memory devices (e.g., card, stick, key drive . . . ), or the like.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or methods herein are intended to include, without being limited to including, these and any other suitable types of memory.

It is to be appreciated and understood that components, as described with regard to a particular system or method, can include the same or similar functionality as respective components (e.g., respectively named components or similarly named components) as described with regard to other systems or methods disclosed herein.

What has been described above includes examples of systems and methods that provide advantages of this disclosure. It is, of course, not possible to describe every conceivable combination of components or methods for purposes of describing this disclosure, but one of ordinary skill in the art may recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

1. An indoor geospatial site builder system, comprising:
a memory that stores computer executable components;
a processor that executes computer executable components;
a site builder component that imports facility plans, transforms the facility plans into Geogrphic Information System (GIS) geometry, and creates maps with one or more layers;
an indoor space visualization component that renders a map containing polygons and GIS coordinates, allows for the definition of metadata;
an asset management and visualization component that creates a visualization of a floor plan using GIS coordinates; and
a location validation component that determines descrepancies between actual location movements of one or more assests and detected location movements of the one or more assests, wherein the actual location movements are stored in travel logs captured by a user and the detected location movements are detected by a real-time location system.

2. The indoor geospatial site builder of system of claim 1, wherein the site builder component stores GIS coordinates.

3. The indoor geospatial site builder system of claim 1, wherein the indoor space component provides that ability to create regions, associate polygons and assign logistical information to each of the polygons.

4. The indoor geospatial site builder system of claim 1, wherein the asset management and visualization component displays the GIS location and asset information associated with one or more assets that are detected by the real-time location system as the one or more assets appear on the facility map.

5. The indoor geospatial site builder system of claim 1, wherein the asset management and visualization component can determine and provide the mechanical and/or physical properties of the asset.

6. The indoor geospatial site builder system of claim 1, wherein the location validation component generates a notification of the discrepencies.

7. A method, comprising:
importing, by a system comprising a processor, facility plans;
transforming, by the system, the facility plans into GIS geometry;
creating, by the system, maps with one or more layers;
rendering, by the system, a map containing polygons and GIS coordinates;
creating, by the system, metadata associated with the polygons;
creating, by the system, a visualization of a floor plan using GIS coordinates; and
determining, by the system, descrepancies between actual location movements of one or more assests and detected location movements of the one or more assests, wherein the actual location movements are stored in travel logs captured by a user and the detected location movements are detected by a real-time location system.

8. The method of claim 7, further comprising storing, by the system, data associated with the transformed GIS geometry.

9. The method of claim 7, wherein the creating maps comprises creating regions, associating polygons and assigning logistical information to each of the polygons.

10. The method of claim 7, where in the rendering comprises displaying the GIS location and asset information associated with one or more assets that are detected by the real-time location system as the one or more assets appear on the facility map.

11. The method of claim 7, where in the creating metadata comprises determining and providing the mechanical and/or physical properties of the asset.

12. The method of claim 7, further comprising generating an alert of the discrepencies.

13. A computer readable storage device comprising instructions that, in response to execution, cause a system comprising a processor to perform operations, comprising:
importing facility plans;
transforming the facility plans into GIS geometry;
creating maps with one or more layers;
rendering a map containing polygons and GIS coordinates;
creating metadata associated with the polygons;
creating a visualization of a floor plan using GIS coordinates; and
determing descrepancies between actual location movements of one or more assests and detected location movements of the one or more assests, wherein the actual location movements are stored in travel logs captured by a user and the detected location movements are detected by a real-time location system.

14. The computer readable storage device of claim 13, wherein the wherein the transformed GIS geometry is stored onto a server.

15. The computer readable storage device of claim 13, wherein the creating maps comprises creating regions, associating polygons and assigning logistical information to each of the polygons.

16. The computer readable storage device of claim 13, wherein the rendering comprises displaying the GIS location and asset information associated with one or more assets that are detected by the real-time location system as the one or more assets appear on the facility map.

17. The computer readable storage device of claim 13, wherein the creating metadata comprises determining and providing the mechanical and/or physical properties of the asset.

18. The computer readable storage device of claim 13, wherein generating the display of asset movement further comprises generating an alert of discrepencies.

19. The indoor geospatial site builder system of claim 1, wherein the location validation component presents the discrepencies by displaying a chart in which the actual location movements and the detected location movements are overlaid.

20. The method of claim 7, further comprising presenting the discrepencies by displaying a chart in which the actual location movements and the detected location movements are overlaid.
